(19) United States
(12) Patent Application Publication
(10) Pub. No.: US 2026/0022281 A1
(43) Pub. Date: Jan. 22, 2026

(54) THICKENED PRIMER FORMULATIONS

(71) Applicant: OATEY CO., Cleveland, OH (US)

(72) Inventors: Raman C. Subrayan, Cleveland, OH (US); Charles Neal Bush, Cleveland, OH (US)

(21) Appl. No.: 19/275,026

(22) Filed: Jul. 21, 2025

Related U.S. Application Data
(60) Provisional application No. 63/673,434, filed on Jul. 19, 2024.

(51) Int. Cl. C09J 133/12; C09J 5/02; C09J 125/14; C09J 133/10

(52) U.S. Cl. CPC C09J 133/12; C09J 5/02; C09J 125/14; C09J 133/10

(57) ABSTRACT

Primer compositions for preparing a polymer surface for solvent cement bonding comprising a thickener and a solvent component.

### CROSS-REFERENCE TO RELATED APPLICATIONS

This application claims the benefit of priority to U.S. Provisional Application No. 63/673,434, filed Jul. 19, 2024, the entire contents of which are incorporated herein by reference.

### TECHNICAL FIELD

The present disclosure relates to primers for use with solvent cement in bonding plastic components together, and more particularly, for use in bonding plastic pipes, fittings, or other components.

### BACKGROUND

Primers are used in the solvent cement process to help prepare plastic pipes, fittings, surfaces, and other articles or objects for joining components or adhesion by cleaning and softening the object to maximize adhesion once a solvent-based cement is subsequently applied. The pipes, fittings, or other objects being adhered are typically made from PVC (polyvinyl chloride), CPVC (chlorinated polyvinyl chloride), ABS (acrylonitrile-butadiene-styrene), or other thermoplastics or polymers. Before applying a solvent cement, the surfaces to be joined are normally covered with a primer containing a solvent capable of at least partially dissolving or “softening” the surface to be bonded.

Conventional primers, however, are usually very low viscosity substances, typically having a viscosity below the viscosity of water. Thus, these low viscosity primers are prone to dripping, spilling, and otherwise separating from the surface of the object to be adhered.

Additionally, because many building codes require that plastic piping systems be primed with primers having an intense colorant, conventional primers usually include a purple dye to facilitate visual confirmation of primer application. The combination of the dye with conventional low viscosity primers can lead to unintentional and undesirable staining and discoloration of the surroundings.

### SUMMARY

Provided herein are primer compositions for preparing a polymer surface for solvent cement bonding, the primer composition comprising a solvent component that is capable of softening the polymer surface, and a solvent-soluble thickener in an amount of about 0.5-6 wt %, based on the total weight of the primer composition, wherein the primer composition has a viscosity of about 10-65 cps as measured according to ASTM D1084, Method B.

Also disclosed are methods of preparing a polymer surface for solvent cement bonding to a further polymer surface comprising applying a primer composition according to the present disclosure to the polymer surface.

The present disclosure also provides methods of making a primer composition for preparing a polymer surface for solvent cement bonding, comprising combining (i) a solvent component that is capable of softening the polymer surface, and (ii) a solvent-soluble thickener in an amount of about 0.5-6 wt %, based on the total weight of the primer composition, wherein the primer composition has a viscosity of about 10-65 cps as measured according to ASTM D1084, Method B.

Also provided are kits comprising (i) a primer composition according to the present disclosure, and (ii) a solvent cement composition.

### BRIEF DESCRIPTION OF THE DRAWINGS

FIG. 1 provides curves for viscosity vs. wt % thickener for primer compositions respectively containing different thickeners.

FIG. 2 provides the results of an assessment of the viscosities of primer compositions containing binary solvent components.

FIG. 3 provides the results of an assessment of the viscosities of primer compositions containing ternary solvent components.

FIG. 4 shows the results of an assessment of the viscosities of primer compositions respectively containing different ratios of MEK, CYH, and ACE in the absence of THF.

FIG. 5 provides the results of an assessment of the viscosities of primer compositions containing quaternary solvent components.

### DETAILED DESCRIPTION

The present invention may be understood more readily by reference to the following detailed description taken in connection with the accompanying examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of the claimed invention.

The disclosures of each patent, patent application, and publication cited or described in this document are hereby incorporated herein by reference, in their entirety.

As employed above and throughout the disclosure, the following terms and abbreviations, unless otherwise indicated, shall be understood to have the following meanings.

In the present disclosure the singular forms “a”, “an”, and “the” include the plural reference, and reference to a particular numerical value includes at least that particular value, unless the context clearly indicates otherwise. Thus, for example, a reference to “a polymer” is a reference to one or more of such compounds and equivalents thereof known to those skilled in the art, and so forth. Furthermore, when indicating that a certain chemical moiety “may be” X, Y, or Z, it is not necessarily intended by such usage to exclude other choices for the moiety; for example, a statement to the effect that a moiety “may be methyl acrylate, butyl acrylate, or methyl methacrylate” does not necessarily exclude other choices for the moiety, such as styrene, or the like.

When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” may refer to a value of 7.2 to 8.8, inclusive; as another example, the phrase “about 8%” may refer to a value of 7.2% to 8.8%, inclusive. Also, when the term “about” precedes a range, it is understood that the term modifies both recited endpoints and all points embraced within the range. For example, the phrase “about 1-10” is understood to mean “about 1 to about 10”, as well as “about x”, wherein x refers to any value between 1 and 10. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” In another example, when a listing of possible choices for a moiety including “methyl acrylate, butyl acrylate, or methyl methacrylate” is provided, the recited listing may be construed as supporting situations whereby any of methyl acrylate, butyl acrylate, or methyl methacrylate is negatively excluded; thus, a recitation of “methyl acrylate, butyl acrylate, or methyl methacrylate” may, when particularly specified, embrace “methyl acrylate or butyl acrylate, but not methyl methacrylate”, or simply “wherein the monomer is not methyl methacrylate”.

Typical primers are very low viscosity substances, typically having a viscosity below the viscosity of water, which is about 1 cp at 20° C. These low viscosity primers are prone to dripping, spilling, and otherwise separating from the surface of the object to be adhered (e.g., a plastic pipe). Also, primers are often dyed so that they have a distinctive and readily distinguishable color (e.g., for code purposes). To satisfactorily dye the primer, specific dye components need to be utilized that often result in a dyed primer that will permanently stain any surface that it contacts. Thus, the combination of dye components with conventional low viscosity primers may lead to unintentional and undesirable staining and discoloration of the surroundings.

ASTM F656-21 provides the most recently updated standard for the properties and functional attributes of primers for use in preparing solvent cement joints of plastic pipes and fittings. The standard specifies, among other things, that viscosity of a primer should be no greater than 65 cps at 25° C.; that the primer should not contain any undissolved particles; that the primer should be capable of dissolving at least 10% by weight of PVC resin at 73±4° F. within 60 minutes; and, that the solution of primer and 10 wt % resin should be free-flowing without “signs of stringiness or gelatin structure”.

The present inventors have discovered a primer formulation that has improved drip properties (e.g., higher viscosity, improved flowability), for example, by virtue of increased viscosity. In certain embodiments, the inventive primer formulation maintains conformity with one or more of the aforementioned requirements of ASTM F656, or may conform to all of the requirements of ASTM F656. Compared to conventional primers, the improved properties include, but are not limited to, less dripping when applied to a surface (e.g., pipe), less dripping from the applicator (e.g., dauber), and less leaking out of the can in which the primer is stored when the can is on its side. Such primers with improved properties comprise a drip improvement material that, in comparison to a conventional material, has higher viscosity and improved flowability (e.g., slower #1 Zahn cup viscosity time). Moreover, the improved characteristics are maintained over an extended period of time, such as during shelf storage.

Accordingly, provided herein are primer compositions for preparing a polymer surface for solvent cement bonding, the primer composition comprising a solvent component that is capable of softening the polymer surface, and a solvent-soluble thickener in an amount of about 0.5-6 wt %, based on the total weight of the primer composition, wherein the primer composition has a viscosity of about 10-65 cps as measured according to ASTM D1084, Method B. In some embodiments, the primer composition is otherwise compliant with ASTM F656.

In some embodiments, the solvent component includes, for example, a lower alcohol, a ketone (e.g., cyclopentanone), an aldehyde, an ester, an ether, a halogenated solvent, N-methyl pyrrolidone, dimethyl-formamide, or any combination thereof. In some embodiments, the solvent component may comprise lower (e.g., C1-8) alcohols such as methanol, ethanol and isopropanol; ketones such as acetone (ACE), methyl ethyl ketone (MEK), methyl isobutyl ketone, isophorone, or cyclohexanone (CYH); esters such as methyl acetate, ethyl acetate, ethyl formate, ethyl propionate, and butyl acetate; ethers such as methyl cellosolve (2-methoxyethanol), and dioxane; and other liquids, such as tetrahydrofuran (THF), N-methyl pyrollidone, and dimethylformamide (DMF). In some embodiments, the solvent component comprises methyl ethyl ketone (MEK), acetone (ACE), cyclohexanone (CYH), methylene chloride, dimethylformamide (DMF), methyl isobutyl ketone (MIBK), 1,3 dioxane, methyl acetate, propyl acetate, N-methyl-2-pyrrolidone (NMP), propylene carbonate, tetrahydrofuran (THF), or any combination thereof. In some embodiments, solvent component comprises THF, MEK, ACE, CYH, or any combination thereof, such as any one, two, three, or all of these specific solvents. For example, the solvent component may comprise or consist of any one, two, or all of MEK, ACE, and CYH.

In certain embodiments, the solvent component does not include tetrahydrofuran (THF). The primer formulation as a whole may be THF-free, by which it is meant that no THF is intentionally included in the formulation, but that there may be up to about 5 wt % of THF (based on the total weight of the primer composition) due to contamination during manufacture of the primer or its constituent ingredients.

The solvent component may comprise about 25-55 wt % MEK, about 5-35 wt % CYH, and about 25-55 wt % ACE, based on the total weight of the primer composition. In certain embodiments, the solvent component comprises about 27-42 wt % MEK, about 10-30 wt % CYH, and about 27-42 wt % ACE, based on the total weight of the primer composition. For example, the solvent component may comprise MEK in an amount of about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt %, based on the total weight of the primer composition. The solvent component may comprise CYH in amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 wt %, based on the total weight of the primer composition. The solvent component may comprise ACE in an amount of about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt %, based on the total weight of the primer composition. The solvent component may comprise a combination of MEK, CYH, and ACE in any of these respective amounts. In some instances, the solvent component consists of a combination of MEK, CYH, and ACE in any of these respective amounts.

The thickener in the present primer compositions is solvent-soluble. This means that, when provided in the concentrations specified in the present disclosure, the thickener is soluble in the solvent or solvent mixture (i.e., the solvent component) of the primer composition. For example, polyvinyl pyrrolidone (PVP), which is water-soluble, may not be solvent-soluble for purposes of the present disclosure or represent a suitable thickener for at least this reason. In any event, the present inventors have tested numerous grades of PVP in primer formulations, and none of the tested PVP samples were able to confer a thickness of 10-65 cps. Consistent with the requirements of ASTM F656-21, the primer composition containing the thickener preferably contains no undissolved particles.

The thickener may have a molecular weight of at least 1,000,000 Dalton. In certain instances, the thickener may have a molecular weight of 1,000,000 Dalton to about 10,000,000 Dalton. For example, the thickener may comprise a homopolymer, copolymer, or a combination thereof having a molecular weight of 1,000,000 Dalton to about 10,000,000 Dalton. The molecular weight of the thickener, whether comprising a homopolymer and/or copolymer or otherwise, may be, for example, 1,000,000 Dalton or greater, such as about 1,100,000, 1,200,000, 1,300,000, 1,400,000, 1,500,000, 1,600,000, 1,700,000, 1,800,000, 1,900,000, 2,000,000, 2,100,000, 2,200,000, 2,300,000, 2,400,000, 2,500,000, 2,600,000, 2,700,000, 2,800,000, 2,900,000, 3,000,000, 3,100,000, 3,200,000, 3,300,000, 3,400,000, 3,500,000, 3,600,000, 3,700,000, 3,800,000, 3,900,000, 4,000,000, 5,100,000, 5,200,000, 5,300,000, 5,400,000, 5,500,000, 5,600,000, 5,700,000, 5,800,000, 5,900,000, 6,000,000, 6,100,000, 6,200,000, 6,300,000, 6,400,000, 6,500,000, 6,600,000, 6,700,000, 6,800,000, 6,900,000, 7,000,000, 7,100,000, 7,200,000, 7,300,000, 7,400,000, 7,500,000, 7,600,000, 7,700,000, 7,800,000, 7,900,000, 8,000,000, 8,100,000, 8,200,000, 8,300,000, 8,400,000, 8,500,000, 8,600,000, 8,700,000, 8,800,000, 8,900,000, 9,000,000, 9,100,000, 9,200,000, 9,300,000, 9,400,000, 9,500,000, 9,600,000, 9,700,000, 9,800,000, 9,900,000, or 10,000,000 Dalton.

The thickener may comprise one or more polymeric ingredients. Thus, the thickener may include one or more polymeric ingredients, preferably as a major constituent, not necessarily to the exclusion of other thixotropic ingredients, such as surfactants, diluents, or the like.

In some instances, the thickener comprises one or more homopolymers, one or more copolymers, or any mixture thereof. For example, the thickener may comprise one or more polymers formed from monomers such as ethyl acrylate, butyl acrylate, isobutyl acrylate, methyl methacrylate, butyl methacrylate, isobutyl methacrylate, methacrylic acid, styrene, or any combination thereof. As used herein, a polymer that is “formed from” a particular monomer was polymerized from the specified monomer, not necessarily to the exclusion of other monomers. For example, a polymer that is “formed from methyl methacrylate” may be a homopolymer of methyl methacrylate or may be a copolymer of methyl methacrylate with one or more other monomer species.

Accordingly, in certain embodiments, the thickener includes a polymer formed from methyl methacrylate. In some embodiments, the thickener includes a polymer formed from ethyl acrylate and methyl methacrylate. In certain instances, the thickener includes a polymer formed from methyl methacrylate, butyl acrylate, and butyl methacrylate. Paraloid™ K120ND includes a copolymer of ethyl acrylate and methyl methacrylate, and may be used as the thickener in the present primer compositions. Paraloid™ K-400 includes a copolymer of butyl acrylate, butyl methacrylate, and methyl methacrylate, and also a copolymer of butyl methacrylate and methyl methacrylate, as well as acrylic polymer, and sodium dodecyl diphenyl ether disulfonate, and may be used as the thickener in the present primer compositions.

In some embodiments, the thickener may be a high molecular weight polyvinyl chloride (PVC) polymer. In this particular context, “high molecular weight PVC polymer” refers to a PVC polymer having a K value of at least 80. The present inventors have discovered that high molecular weight PVC polymers are qualitatively different from other PVC polymers in terms of the capacity of the former to contribute to the formation of a primer composition having a viscosity of about 10-65 cps as measured according to ASTM D1084, Method B, when present in the primer composition in an amount of about 0.5-6 wt %. In other embodiments, the thickener is not a PVC polymer.

The thickener may be present in the primer composition in an amount of about 0.5-6 wt %, based on the total weight of the primer composition. For example, the thickener may be present in an amount of about 0.5, 0.75, 1.0, 1.25, 1.5, 1.75, 2.0, 2.25, 2.5, 2.75, 3.0, 3.25, 3.5, 3.75, 4.0, 4.25, 4.5, 4.75, 5.0, 5.25, 5.5, 5.75, or 6 wt %, based on the total weight of the primer composition. In certain embodiments, the amount of thickener in the primer composition is about 1-6 wt %, about 2-5 wt %, about 2-4 wt %, or about 2-3 wt %, based on the total weight of the primer composition.

Viscosity of the present primer compositions may be 10-65 cps, as measured according to ASTM D1084. Accordingly, the primer compositions may have a viscosity of, for example, about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65 cps, as measured according to ASTM D1084. It is noted that ASTM F656-21, the standard governing the properties of primer compositions, does not include a viscosity measurement methodology. Accordingly, in order to provide a standard for reliable measurement of viscosity of the present primer compositions, the present inventors used the viscosity measurement process described in ASTM D1084 (which represents a standard for measuring free-flowing adhesives) to assess viscosity.

In some embodiments, the present primer compositions further include one or more dye components, which can include, without limitation, any dye components known to be used or typically found in tinted primers. Alternatively, the primer compositions may exclude any components that are for the purpose of forming a tinted primer.

The present disclosure also provides methods of preparing a polymer surface for solvent cement bonding to a further polymer surface comprising applying a primer composition according to any of the embodiments described in the present disclosure to the polymer surface. The polymer surface may be a surface of any article that requires bonding to another component, such as a surface of a section of plastic pipe or a fitting that is to be bonded using solvent cement to another component, such as a further section of pipe or to a fitting. The polymer surface may comprise any polymer material that can be bonded using a solvent cement, such as PVC (polyvinyl chloride), CPVC (chlorinated polyvinyl chloride), ABS (acrylonitrile butadiene styrene), or any combination thereof.

The primer composition may be applied to the polymer surface by any process that is suitable for contacting the polymer surface with the primer to a sufficient degree as to prepare it for bonding to a further polymer surface. For example, any technique for contacting the polymer surface with the primer such as to effect softening of the polymer surface to some degree may be used. Exemplary processes for applying the primer composition include pouring, spraying, daubing, or brushing the primer composition onto the polymer surface.

Also disclosed herein are methods of making a primer composition for preparing a polymer surface for solvent cement bonding, comprising combining (i) a solvent component that is capable of softening the polymer surface, and (ii) a solvent-soluble thickener in an amount of about 0.5-6 wt %, based on the total weight of the primer composition, wherein the primer composition has a viscosity of about 10-65 cps as measured according to ASTM D1084, Method B. The primer composition may be compliant with some or all of the requirements of ASTM F656. In accordance with these methods, the solvent component may be in accordance with any of the embodiments described supra in connection with the inventive primer compositions. Likewise, the thickener may be in accordance with any of the embodiments described supra in connection with the inventive primer compositions.

The present disclosure also provides kits comprising (i) a primer composition according to any of the embodiments described supra in connection with the inventive primer compositions and (ii) a solvent cement composition. The primer composition is provided in a first container, such as a can or tube, and the solvent cement composition is provided in a second container. The solvent cement composition should be suitable for solvent cement bonding of a polymer surface that can be softened using the primer composition to a further polymer surface. In certain embodiments, the solvent cement composition comprises one or more of the particular solvents that are included in the solvent component of the primer composition. For example, in a situation where the primer includes MEK, CYH, and ACE, the solvent cement may also include MEK, CYH, and ACE. However, the solvent(s) in the solvent cement need not all be the same as the solvent(s) in the primer; or, the solvent cement can include one or more solvents that are not in the primer; or, the primer can include one or more solvents that are not in the solvent cement. For example, in a situation where the primer includes MEK, CYH, and ACE, the solvent cement may include MEK, CYH, ACE, and THF.

Also disclosed herein are kits comprising (i) a can defining an opening and an interior space that contains a primer composition according to any of the embodiments described supra in connection with the inventive primer compositions, wherein the can comprises a cap for sealing the opening of the can, and (ii) a dauber for applying the primer composition onto a substrate, wherein the dauber is optionally affixed to a portion of the cap that faces the interior space of the can when the cap is positioned over the opening. The can may be sized and constructed as appropriate for providing durable and leakproof containment of the primer composition and typically, cans for housing primers are constructed from steel or another suitable metal, and can have a volume of about 1 to 50 ounces, such as 1, 4, 8, 12, 16, 24, 28, 32, 36, 40, 44, 48, or 50 ounces.

The opening of the can may be sufficiently sized to allow access to a dauber. The opening of the can may be bounded by a flange that interacts with the cap in order to seal the opening. The flange may interact with the cap in any suitable manner, such as by an interference fit or by threaded engagement with the cap. The cap is preferably formed from the same material as the main body of the can.

The dauber includes a portion that is capable of taking up a quantity of the primer composition so that it can be applied to a substrate. This portion may be a brush, sponge, fabric, or any material that is capable of taking up a suitable quantity of the primer composition. Any existing design for the portion of a dauber that is configured for taking up and applying primer compositions to a substrate may be used in accordance with the present kits. The portion that is used to take up primer composition may be attached to a distal end of an elongate stem that also has a proximal end that is affixed to a handle or to the underside of the cap of the can. The stem is preferably of a sufficient length, or may be adjusted to be of a sufficient length, such that the portion of the dauber at the distal end of the stem may reach the bottom of the interior of the can, so that primer composition at the bottom of the can may be taken up by the dauber.

In one embodiment, the dauber (including the stem) and handle are provided as separate elements from the cap and the can. In other embodiments, the proximal end of the stem is affixed to a portion of the cap that faces the interior space of the can when the cap is positioned over the opening, i.e., to the underside of the cap. In the latter embodiment, the dauber and stem will be positioned within the interior of the can when the opening of the can is sealed using the cap, for example, during storage of the can.

### EXAMPLES

The following examples illustrate exemplary embodiments and features of various primer compositions encompassed by the general inventive concepts. The examples are given solely for the purpose of illustration and are not to be construed as limiting the present disclosure, as many variations thereof are possible and also encompassed by the general inventive concepts.

### Example 1—Thickener Comparisons

To identify candidate thickeners, primer compositions respectively containing various acrylic resins at different concentrations were prepared as listed below in Table 1b, and their viscosities were measured. The solvent component of the tested primer compositions included 40% ACE, 30% CYH, and varying amounts of MEK depending on the concentration of resin. Exemplary formulations are as follows:

TABLE 1a

| | Exp. No. | | | | |
|---|---|---|---|---|---|
| | 1 | 2 | 3 | 4 | 5 |
| | wt % | | | | |
| ACE | 40 | 40 | 40 | 40 | 40 |
| CYH | 30 | 30 | 30 | 30 | 30 |
| MEK | 28 | 27 | 24 | 20 | 15 |
| Thickener | 2 | 3 | 6 | 10 | 15 |

TABLE 1b

| | | | | | Thickener | | | | |
|---|---|---|---|---|---|---|---|---|---|
| Candidate | Supplier/ | Molecular | | | Concentration | | | | |
| Thickener | Manufacturer | Weight | | Monomer(s) | 2% | 3% | 6% | 10% | 15% |
| MB318A | Pioneer Chemicals | 35,000 | | BMA/MMA | | 10 | 10 | 10 | 10 |
| MB258 | Pioneer Chemicals | 80,000 | | MMA | | 0 | 0 | 0 | 10 |
| Paraloid | Dow | | | Styrene/ | | 0 | 0 | — | — |
| K-175 | | | | BMA/BA | | | | | |
| MB-3-A | Pioneer Chemicals | 105,000 | | MMA/MA | | 0 | 10 | 10 | 20 |
| MB-18-A | Pioneer Chemicals | 120,000 | | IBMA/MAcid | | 0 | 10 | 10 | 20 |
| ELVACITE | Mitsubishi | 397,000 | | MMA | | 0 | 10 | 10 | — |
| 2041 | Chemicals | | | | | | | | |
| MB247A | Pioneer Chemicals | 450,000 | | MMA | | 10 | 10 | 140 | 1390* |
| PMMA | Sigma-Aldrich | 996,000 | | MMA | | 0 | 10 | 130 | PS |
| Paraloid | Dow | 1 | Million | EA/MMA | | 0 | 30 | 330 | 6310 |
| K120ND | | | | | | | | | |
| PA-20 | Kaneka | 1 | Million | MMA | | 10 | 70 | 450 | 21,300 |
| Paraloid | Dow | 4-5 | Million | BA/BMA/MMA | | 60 | 1190 | PS | PS |
| K-400 | | | | | | | | | |
| Paraloid | Dow | | | BA/BMA/MMA | 20 | 80 | 1782 | — | — |
| K-445 | | | | | | | | | |
| PA-40 | Kaneka | 5-7 | Million | MMA | 40 | 180 | PS | PS | PS |

BMA: Butyl methacrylate
MMA: Methyl methacrylate
MA: Methyl acrylate
IBMA: Isobutyl methacrylate
MAcid: Methacrylic acid
EA: Ethyl acrylate
BA: Butyl acrylate
*Mostly Dissolved
PS: Partly Soluble

Molecular weights and specific contents of the Paraloid™ resins are not formally disclosed but the listed properties were obtained by the inventors. Comparing the viscosities at 3%, it is possible that the molecular weight of K-400 is less than that of PA-40. PMMA resin from Sigma-Aldrich did not completely dissolve at 10-15% level whereas the Kaneka and Paraloid resins with even higher molecular weights dissolved, possibly due to the incorporation of the butyl and ethyl acrylates in the backbone that may have enhanced the solubility.

### Example 2—Viscosity Vs. Concentration Study

Primer compositions comprising either Paraloid™ K120ND or Paraloid™ K-400 were prepared. Viscosity was assessed according to ASTM D1084 for respective compositions with varying amounts of thickener, and Table 2 shows results for 2-7 wt % of thickener:

TABLE 2

Wt. %

| | | | | | | |
|---|---|---|---|---|---|---|
| ACE | 40 | 40 | 40 | 40 | 40 | 40 |
| CYH | 30 | 30 | 30 | 30 | 30 | 30 |
| MEK | 28 | 27 | 26 | 25 | 24 | 23 |
| Thickener | 2 | 3 | 4 | 5 | 6 | 7 |

Viscosity (cp)

| | | | | | | |
|---|---|---|---|---|---|---|
| Paraloid K400 | 20 | 70 | 220 | 570 | 1190 | |
| Paraloid K120ND | 0 | 0 | 10 | 20 | 30 | 60 |

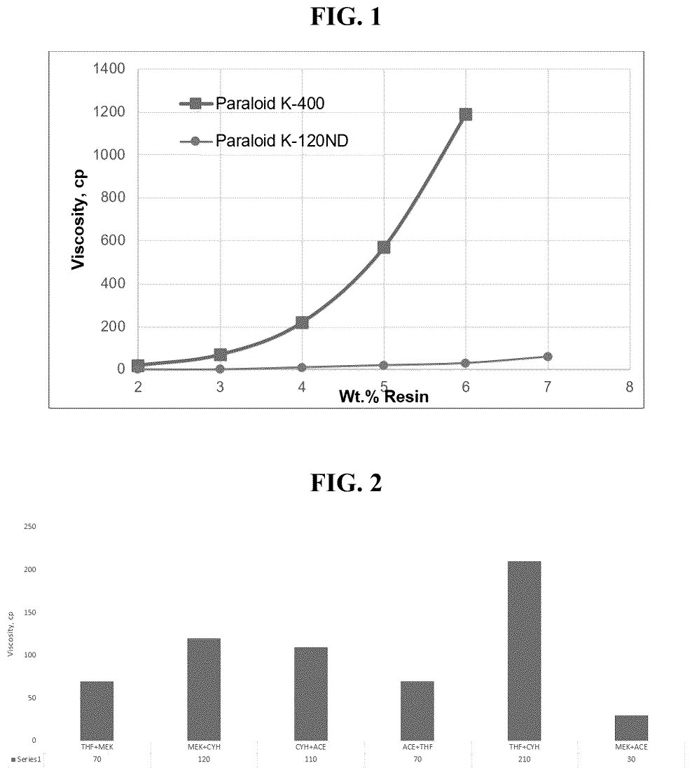

FIG. 1 provides the curves for viscosity vs. wt % thickener for the samples containing Paraloid™ K120ND and Paraloid™ K-400, respectively. Use of the latter in the primer compositions yielded higher viscosities.

### Example 3—Aging Study

Exemplary primer compositions respectively containing MEK, CYH, and ACE as primers, either Paraloid™ K120N or Paraloid™ K120ND as thickeners, and optionally containing dye components for providing a purple appearance were assessed for initial viscosity, and for viscosity at 140° F. after various periods of time ranging from one month to seven months following preparation. Results are provided in Table 3, below:

TABLE 3

| | | Sample | | | | | | |
|---|---|---|---|---|---|---|---|---|
| | | 1 | 2 | 3 | 4 | 5 | 6 | 7 |
| MEK | | 23.00% | 24.00% | 23.20% | 25.92% | 25.92% | 24.42% | 22.00% |
| CYH | | 30.00% | 30.00% | 30.00% | 30.00% | 30.00% | 30.00% | 30.00% |
| ACE | | 40.00% | 40.00% | 40.00% | 40.00% | 40.00% | 40.00% | 40.00% |
| K120N | | 7.00% | 6.00% | | | | | |
| K120ND (NEW LOT) | | | | 6.00% | 4.00% | 4.00% | 5.50% | 8.00% |
| Violet Dye | | | | 0.06% | 0.06% | 0.06% | 0.06% | |
| Red Dye | | | | 0.02% | 0.02% | 0.02% | 0.02% | |
| TOTAL | | 100.00% | 100.00% | 99.28% | 100.00% | 100.00% | 100.00% | 100.00% |
| Viscosity (10 RPM, | | | | | | | | |
| 17 sec, cp) | | | | | | | | |
| Initial | | 60 | 40 | 40 | 10 | 20 | 30 | 130 |
| 24 h | | 60 | 30 | 60 | 10 | 20 | 40 | 200 |
| Viscosity vs. Shear Data | | | | | | | | |
| RPM | | | | | | | | |
| 2.5 | | 80 | 40 | 80 | 40 | 80 | 40 | 80 |
| 5 | | 80 | 40 | 60 | 20 | 40 | 40 | 120 |
| 10 | | 70 | 50 | 50 | 20 | 30 | 40 | 130 |
| 20 | | 70 | 45 | 50 | 20 | 30 | 40 | 135 |
| 50 | | 72 | 48 | 58 | 26 | 36 | 46 | 140 |
| 100 | | 86 | 63 | 73 | 34 | 48 | 61 | 148 |
| 140 F. Viscosity Data | | | | | | | | |
| (10 RPM, 17 sec, cp) | | | | | | | | |
| 1 | Month | 60 | 30 | 70 | | | | 150 |
| 2 | Months | 60 | 40 | 40 | | | | 160 |
| 3 | Months | 50 | 30 | 50 | | | | 150 |
| 4 | Months | 60 | 30 | 70 | | | | 170 |
| 5 | Months | 70 | 40 | 60 | | | | 160 |
| 6 | Months | 80 | 50 | 70 | | | | 180 |
| 7 | Months | 100 | 50 | 70 | | | | |
| 8 | Months | 90 | 50 | 60 | | | | |
| 9 | Months | 110 | 70 | 70 | | | | |
| 10 | Months | 110 | 70 | | | | | |
| 11 | Months | 130 | 80 | | | | | |
| 12 | Months | 140 | 70 | | | | | |

As shown in Table 3, samples containing at least 6 wt % of either type of thickener provided stable viscosity over time.

### Example 4—Evaluation of Aging and Lap Shear Strength

Primer compositions respectively containing 2 wt % Paraloid™ K-400, 3 wt % Paraloid™ K-400, or no thickener were prepared and assessed for aging. An assessment was also made of the primer compositions for preparing a polymer surface for solvent cement bonding by measuring lap shear strength of a bond that was formed by applying the primer composition to a polymer surface, applying a solvent cement formulation (designated “215”, corresponding to Oatey® Heavy Duty Clear PVC Cement) to the primed polymer surface, and bonding the surface to a further polymer surface. Aging and lap shear results are shown below in Tables 4 and 5. Table 4 provides results concerning use of inventive primer compositions containing 2 and 3 wt % Paraloid™ K-400, respectively (Samples 1 and 2). Table 5 provides results concerning use of a primer composition not containing any thickener according to the present disclosure, and of an existing, dyed primer formulation that includes a solvent mixture that includes THF and does not contain any thickener (Samples 3 and 4, respectively).

TABLE 4

| | Sample No. | |
|---|---|---|
| | 1 | 2 |
| THF | | |
| MEK | 26.92% | 27.92% |
| CYH | 30.00% | 30.00% |
| ACE | 40.00% | 40.00% |
| Paraloid K400 | 3.00% | 2.00% |
| Violet Dye | 0.060% | 0.060% |
| Red Dye | 0.020% | 0.020% |
| TOTAL | 100.00% | 100.00% |

| | | Room | | | | | Room | | | | |
|---|---|---|---|---|---|---|---|---|---|---|---|
| Viscosity | | Temp | 40° | 90° | 140° | 0 F. | Temp | 40° | 90° | 140° | 0 F. |
| As made | | 60 | | | | | 10 | | | | |
| 24 | h | 60 | | | | | 40 | | | | |
| 1 | week | 80 | 100 | 80 | 70 | 120 | 30 | 40 | 30 | 30 | 40 |
| 2 | weeks | 80 | 110 | 90 | 80 | 80 | 40 | 50 | 40 | 40 | 50 |
| 3 | weeks | 70 | 90 | 80 | 70 | 120 | 30 | 40 | 30 | 30 | 40 |
| 4 | weeks | | | | | | | | | | |
| 1 | month | | | | 50 | | | | | 10 | |

| | | |
|---|---|---|
| Density, lbs/gal | 7.046 | 7.024 |
| Lap Shear | Primer + 215 | Primer + 215 |
| 2 Hr (avg) psi | 225 | 255 |
| 16 Hr (avg) psi | 462 | 465 |
| 72 Hr (avg) psi | 739 | 795 |
| 2 h Burst Strength (psi) | 451 | 454 |
| Dissolution Test (Pass/Fail) | Pass | Will pass |
| Aging Study | | |
| 1 month @ 140 F. | 50 | 10 |
| 2 months @ 140 F. | 60 | 20 |
| 3 months @ 140 F. | 60 | 20 |
| 4 months @ 140 F. | 60 | 20 |
| 5 months @ 140 F. | 50 | 10 |
| 6 months @ 140 F. | 50 | 10 |

TABLE 5

Sample No.

| | 3 | 4 |
|---|---|---|
| THF | | 15.07% |
| MEK | 29.92% | 19.93% |
| CYH | 30.00% | 25.00% |
| ACE | 40.00% | 39.92% |
| Paraloid K400 | | |
| Violet Dye | 0.060% | 0.062% |
| Red Dye | 0.020% | 0.018% |
| TOTAL | 100.00% | 100.00% |

| Viscosity | | RT | 40° | 90° | 140° | 0 F. | RT | 40° | 90° | 140° | 0 F. |
|---|---|---|---|---|---|---|---|---|---|---|---|
| As made | | 10 | | | | | 0 | | | | |
| 24 | h | 10 | | | | | 0 | | | | |
| 1 | week | | | | | | | | | | |
| 2 | weeks | | | | | | | | | | |
| 3 | weeks | | | | | | | | | | |
| 4 | weeks | | | | | | | | | | |
| 1 | month | | | | 0 | | | | | | |

| | | |
|---|---|---|
| Density, lbs/gal | 6.969 | |
| Lap Shear | Primer + 215 | Primer + 215 |
| 2 Hr (avg) psi | 312 | 306 |
| 16 Hr (avg) psi | 464 | 513 |
| 72 Hr (avg) psi | 931 | 940 |
| 2 h Burst Strength (psi) | 582 | 513 |
| Dissolution Test (Pass/Fail) | Will pass | Pass |
| Aging Study | | |
| 1 month @ 140 F. | 0 | |
| 2 months @ 140 F. | 0 | |
| 3 months @ 140 F. | 0 | |
| 4 months @ 140 F. | 0 | |
| 5 months @ 140 F. | 0 | |
| 6 months @ 140 F. | 0 | |

### Example 5—Aging and Bonding Study

Primer compositions having formulations as shown in Table 6, below, were prepared and subjected to aging studies. Additionally, lap shear and bond strength were assessed as shown with respect to bonds formed by applying the respective primer compositions to a polymer surface, applying a solvent cement formulation (Oatey® Heavy Duty Clear PVC Cement) to the primed polymer surface, and bonding the surface to a further polymer surface.

TABLE 6

| | Sample No. | | | | | |
|---|---|---|---|---|---|---|
| | | 2 (Purple | | | | |
| | 1 | primer) | 3 | 4 | 5 | 6 |
| THF | | 15.07% | | | 15.07% | |
| MEK | 27.42% | 19.93% | 29.92% | 27.42% | 19.93% | 27.42% |
| CYH | 30.00% | 25.00% | 30.00% | 30.00% | 25.00% | 30.00% |
| ACE | 40.00% | 39.92% | 40.00% | 40.00% | 39.92% | 40.00% |
| Paraloid K400 | 2.50% | | | 2.50% | | |
| Violet Dye | 0.06% | 0.06% | 0.06% | | | |
| Red Dye | 0.02% | 0.02% | 0.02% | | | |
| TOTAL | 100.00% | 100.00% | 100.00% | 99.92% | | 97.42% |

| | | Room | | | | | | | | | |
|---|---|---|---|---|---|---|---|---|---|---|---|
| Viscosity | | Temp | 40° | 90° | 140° | 0 F. | RT | 0 | 30 | 0 | 0 |
| As made | | 30 | | | | | 0 | 0 | | | |
| 24 | h | 40 | | | | | 0 | | | | |
| 1 | week | 30 | 40 | 30 | 30 | 60 | | | | | |
| 2 | weeks | 30 | 40 | 20 | 20 | 50 | | | | | |
| 3 | weeks | 40 | 50 | 30 | 40 | 60 | | | | | |
| 4 | weeks | 30 | 40 | 30 | 20 | 60 | | | | | |
| 1 | month | 40 | 50 | 30 | 20 | 60 | | | | | |
| 2 | months | 30 | 50 | 30 | 30 | 50 | | | | | |
| 3 | months | 30 | 40 | 30 | 20 | 40 | | | | | |
| 4 | months | 30 | 40 | 30 | 20 | 40 | | | | | |
| 5 | months | 40 | 50 | 40 | 30 | 50 | | | | | |
| 6 | months | 30 | 50 | 40 | 40 | 50 | | | | | |
| 7 | months | 40 | 50 | 40 | 40 | 60 | | | | | |

| | | | | | | |
|---|---|---|---|---|---|---|
| Density, lbs/gal | 7.045 | | 6.969 | | | |
| Dissolution Test (Pass/Fail) | Pass | Pass | | | | |
| Lap Shear - 2 Hr (avg) psi | 263 | 308 | 312 | 234 | 266 | 281 |
| Lap Shear - 16 Hr (avg) psi | 451 | 513 | 464 | 483 | 476 | 521 |
| Lap Shear - 72 Hr (avg) psi | 774 | 940 | 931 | 958 | 1009 | 986 |
| 2 h Burst Strength (psi) | 484 | 513 | 582 | 439 | 528 | 582 |

With respect to Sample 1 containing 2.5% K-400, a viscosity of 30-40 cp was observed. This formulation also passed the dissolution test. Therefore, further evaluations of this formula were conducted.

### Example 6—Aging and Bonding Study For Primer Compositions Containing THF

Primer compositions having formulations as shown in Table 7 were prepared and subjected to aging studies. The control formulation did not contain a thickener in accordance with the present disclosure. Lap shear and bond strength were also assessed as shown with respect to bonds formed by applying the respective primer compositions to a polymer surface, applying a solvent cement formulation (Oatey® Heavy Duty Clear PVC Cement) to the primed polymer surface, and bonding the surface to a further polymer surface.

TABLE 7

Sample

| | Control | 1 | 2 | 3 |
|---|---|---|---|---|
| THF | 15.07% | 14.54% | 14.62% | 14.69% |
| MEK | 19.93% | 19.33% | 19.43% | 19.53% |
| CYH | 25.00% | 24.22% | 24.35% | 24.46% |
| ACE | 39.90% | 38.83% | 39.03% | 39.21% |
| Paraloid K-400 | | 3.00% | 2.49% | 2.04% |
| Violet Dye | 0.062% | 0.062% | 0.06% | 0.06% |
| Red Dye | 0.018% | 0.018% | 0.02% | 0.02% |
| TOTAL | 99.98% | 100.00% | 100.00% | 100.00% |
| Viscosity | | | | |
| As made | 0 | 60 | 30 | 20 |
| 24 h | 0 | 70 | 30 | 20 |

| | RT | 40 F. | 90 F. | 140 F. | 0 F. | RT | 40 F. | 90 F. | 140 F. | 0 F. | RT | 40 F. | 90 F. | 140 F. | 0 F. |
|---|---|---|---|---|---|---|---|---|---|---|---|---|---|---|---|
| Week 1 | 80 | 110 | 80 | 70 | 130 | 60 | 70 | 60 | 60 | 80 | 40 | 60 | 30 | 50 | 50 |
| Week 2 | 60 | 80 | 60 | 60 | 110 | 30 | 40 | 40 | 30 | 50 | 20 | 20 | 10 | 20 | 30 |
| Week 3 | 60 | 90 | 70 | 60 | 110 | 20 | 30 | 20 | 20 | 30 | 40 | 40 | 40 | 30 | 50 |
| Week 4 | 60 | 80 | 60 | 60 | 100 | 30 | 40 | 40 | 30 | 40 | 10 | 20 | 20 | 10 | 20 |
| 1 month | 50 | 80 | 70 | 70 | 100 | 30 | 40 | 30 | 20 | 40 | 10 | 20 | 10 | 10 | 10 |
| 2 months | 60 | 80 | 60 | 60 | 120 | 30 | 40 | 30 | 30 | 40 | 10 | 20 | 20 | 20 | 40 |
| 3 months | 60 | 80 | 60 | 60 | 90 | 30 | 40 | 40 | 30 | 40 | 10 | 20 | 10 | 10 | 20 |
| 4 months | 60 | 80 | 60 | 60 | 90 | 30 | 50 | 30 | 30 | 40 | 10 | 20 | 10 | 10 | 20 |
| 5 months | 70 | 90 | 70 | 70 | 90 | 20 | 40 | 20 | 20 | 30 | 40 | 60 | 40 | 40 | 50 |
| 6 months | 60 | 90 | 70 | 70 | 100 | 40 | 60 | 40 | 40 | 50 | 20 | 40 | 30 | 20 | 30 |

| | | | | |
|---|---|---|---|---|
| Freezer Test (# of days until gel) | | 30+ | 30+ | 30+ |
| Density (lbs/gal) | | 7.092 | 7.078 | 7.071 |
| Lap Shear - 2 Hr (avg) psi | 394 | | 246 | 234 |
| Lap Shear - 16 Hr (avg) psi | 840 | | 418 | 511 |
| Lap Shear - 72 Hr (avg) psi | 1407 | | 730 | 771 |
| Burst Strength (psi) | 615 | | 636 | 528 |
| Dissolution Test (Pass/Fail) | Pass | | | |
| Heat Stability Test (Visc in | | 70 | 20 | 10 |
| cP after 30 days at 140° F.) | | | | |

### Example 7—Study of Solvent Component Effect on Primer Viscosity

Binary and ternary solvent components (i.e., solvent components respectively containing two or three different solvents) were prepared and assessed for their effect on viscosity when using exemplary thickener Paraloid™ K-400.

First, two solvents (selected from THE, MEK, CYH, and ACE) were mixed in equal weights in a 4 ounce can, and 3 wt % Paraloid™ K-400 was dissolved by heating at 140° F. for 1-4 days with occasional vigorous shaking, after which time steady viscosity measurements were made using ASTM D1084, Method B. Results of the viscosity measurements for each solvent combination are shown in FIG. 2. The combination of THF+CYH had the highest viscosity. Among the other solutions, the other combinations that included CYH had relatively high viscosities. THF-containing solutions had lower viscosities, but were higher than the viscosity of the MEK+ACE combination.

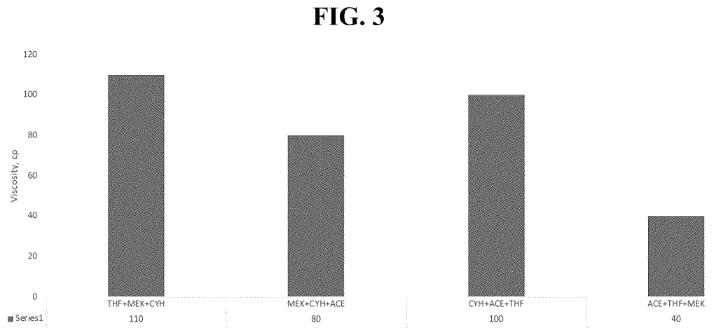

Next, three solvents (selected from THE, MEK, CYH, and ACE) were mixed in equal weights in a 4 ounce can, and 3 wt % Paraloid™ K-400 was dissolved therein by heating at 140° F. for 1-4 days with occasional vigorous shaking, after which time steady viscosity measurements were made using ASTM D1084, Method B. Results of the viscosity measurements for each solvent combination are shown in FIG. 3. Among the ternary mixtures, CYH-containing combinations had higher viscosity.

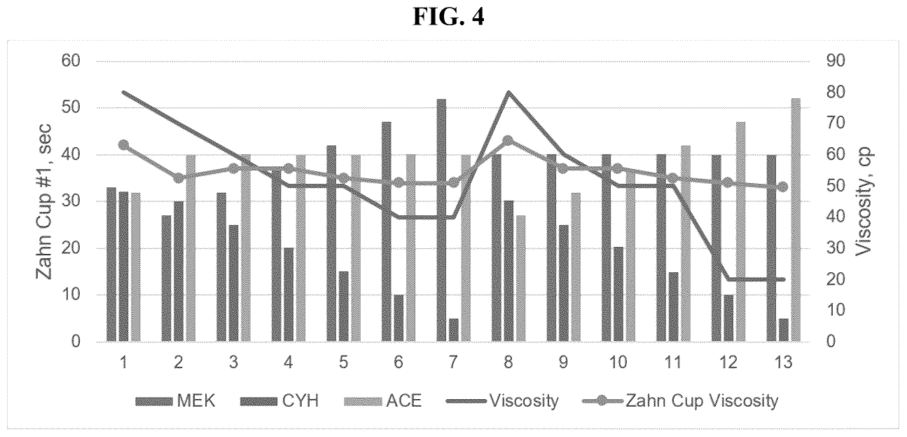

Governmental regulations increasingly impose limits on high-VOC materials. In view of such regulations, it is advantageous to provide THE-free primer compositions. Accordingly, a subsequent study investigated the effect of varying the ratios of MEK, CYH, and ACE in the absence of THF. The respective mixtures were each formed in 4 ounce cans, and 3 wt % Paraloid™ K-400 was dissolved therein by heating at 140° F. for 1-4 days with occasional vigorous shaking, after which time steady viscosity measurements were made using ASTM D1084, Method B. Results of the viscosity measurements for each solvent combination are shown in FIG. 4. Numerical data is provided in Table 8, below:

TABLE 8

| | Sample No. | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| MEK | 33 | 27 | 32 | 37 | 42 | 47 | 52 | 40 | 40 | 40 | 40 | 40 | 40 |
| CYH | 32 | 30 | 25 | 20 | 15 | 10 | 5 | 30 | 25 | 20 | 15 | 10 | 5 |
| ACE | 32 | 40 | 40 | 40 | 40 | 40 | 40 | 27 | 32 | 37 | 42 | 47 | 52 |
| Paraloid K400 | 3 | 3 | 3 | 3 | 3 | 3 | 3 | 3 | 3 | 3 | 3 | 3 | 3 |
| TOTAL | 100 | 100 | 100 | 100 | 100 | 100 | 100 | 100 | 100 | 100 | 100 | 100 | 100 |
| Viscosity, cp | 80 | 70 | 60 | 50 | 50 | 40 | 40 | 80 | 60 | 50 | 50 | 20 | 20 |
| Zahn | 42 | 35 | 37 | 37 | 35 | 34 | 34 | 43 | 37 | 37 | 35 | 34 | 33 |
| Cup #1, sec | | | | | | | | | | | | | |

As shown, sample I contained roughly equal amounts of the three solvents (33% MEK. 32% CYH, and 32% ACE). In certain parts of the study. ACE was kept constant at 40% and the MEK and CYH were gradually altered. In other parts of the study, MEK was kept constant at 40%, and the ACE and CYH were gradually altered.

The results demonstrated that viscosity decreases with decreasing concentration of CYH. The sample with the highest concentration of ACE and the lowest concentration of CYH had the lowest viscosity (sample 13).

The results also demonstrated several combinations of MEK, CYH, and ACE can be used in order to produce desirable viscosity (e.g., 40-60 cps).

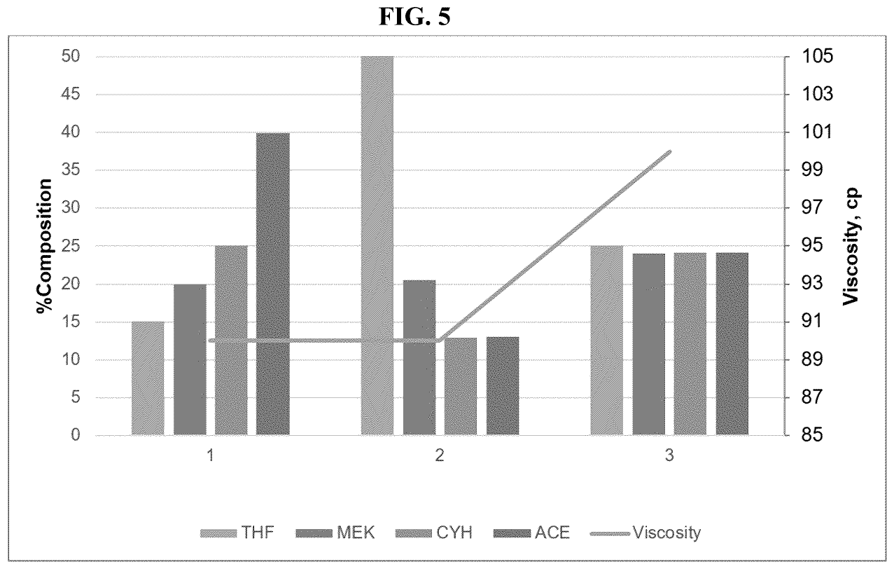

Next, primer compositions containing quaternary solvent components (i.e., solvent components containing four solvents, namely, MEK, CYH, ACE, and THF) were assessed. The respective mixtures were each formed in 4 ounce cans, and 3 wt % Paraloid™ K-400 was dissolved therein by heating at 140° F. for 1-4 days with occasional vigorous shaking, after which time steady viscosity measurements were made using ASTM D1084, Method B. Results of the viscosity measurements for each solvent combination are shown in FIG. 5. As shown in the figure, viscosities of the respective compositions remained steady at about 90-100 cps despite variations in respective solvent concentrations.

### Example 8—Flowability Assessment

Exemplary compositions were respectively assessed concerning flowability using the #1 Zahn cup methodology, which is specified in ASTM D4212, and involves dipping a calibrated cup into the liquid, then lifting it out and measuring the time it takes for the liquid to flow through a specific orifice at the bottom. This flow time is then related to viscosity. Table 9, below, provides results:

TABLE 9

| Sample No. | 1 | 2 | 3 | 4 |
|---|---|---|---|---|
| MEK | 29.90% | 26.90% | 27.90% | 27.40% |
| CYH | 30.00% | 30.00% | 30.00% | 30.00% |
| ACE | 40.00% | 40.00% | 40.00% | 40.00% |
| Paraloid K400 | 0.00% | 3.00% | 2.00% | 2.50% |
| Violet Dye | 0.10% | 0.10% | 0.10% | 0.10% |
| Red Dye | 0.00% | 0.00% | 0.00% | 0.00% |
| Viscosity, cp | 10 | 60 | 20 | 40 |
| Zahn Cup #1, Sec | 22 | 35 | 26 | 30 |

### Example 9—Shear Thinning Assessment

An assessment was conducted of the effect of shear and thickener type on Brookfield viscosity using spindle #3 at room temperature. Test samples and results are shown in Table 10, below. Solvent ratios were as follows: 40% ACE. 30% CYH. 15-27% MEK (wherein the concentration of MEK is varied according to the concentration of thickener).

TABLE 10

| | Purple | | | | | | | | | | | OV310 |
|---|---|---|---|---|---|---|---|---|---|---|---|---|
| | Primer | K-120ND | K-400 | MB247A | | | | MB-318-A | | | | (K = 82) |
| Thickener | Concentration | 4% | 2.50% | 3% | 6% | 10% | 15% | 3% | 6% | 10% | 15% | 3% |
| Revolutions/ | | | | | | | | | | | | |
| minute(RPM) | | | | | | | | | | | | |
| 2 | 0 | 40 | 50 | 0 | 0 | 150 | 1050 | 0 | 0 | 0 | 0 | 50 |
| 5 | 0 | 20 | 40 | 0 | 20 | 180 | 980 | 0 | 0 | 0 | 0 | 60 |
| 10 | 0 | 20 | 30 | 0 | 20 | 170 | 1010 | 0 | 0 | 0 | 0 | 60 |
| 20 | 0 | 20 | 35 | 5 | 20 | 175 | 965 | 5 | 5 | 5 | 5 | 65 |
| 50 | 4 | 26 | 42 | 12 | 30 | 176 | 966 | 12 | 6 | 8 | 6 | 58 |
| 100 | 6 | 34 | 55 | 16 | 40 | 186 | 968 | 16 | 8 | 11 | 7 | 57 |
| 200 | 8 | | 71 | 27 | 58 | 212 | E | 22 | 11 | 15 | 10 | 66 |

Generally, the viscosities remained steady or decreased with increase in shear, even in the case of purple-dyed primer without thickener (first data column in Table 10). Viscosities did increase with molecular weight and concentration. Viscosities also increased at higher RPM values. However, the viscosity of the OxyChem OV310 PVC resin solution remained essentially steady with increasing RPM.

### Example 10—Aging Studies in Single-Solvent Compositions

Aging studies (viscosity over time and at various temperatures) were performed for primer compositions respectively containing 3% Paraloid™ K-400 solutions and 97% of single solvent. The compositions were prepared by dissolving the K-400 in the solvent at 1600 RPM shear in 30 minutes. The results are provided below in Table 11.

TABLE 11

Sample No.

| | 1 | 2 | 3 | 4 |
|---|---|---|---|---|
| THF | | | | 97% |
| MEK | 97% | | | |
| CYH | | | 97% | |
| ACE | | 97% | | |
| Paraloid K-400 | 3% | 3% | 3% | 3% |
| TOTAL | 100% | 100% | 100% | 100% |
| Appearance | Hazy | Hazy | Almost clear | Hazy |
| Viscosity, cp | | | | |
| As made | 40 | 30 | 250 | 100 |
| 24 h | 40 | 40 | 280 | 100 |
| Overnight @ 140/120° F. | 40 | 30 | 240 | 90 |

| | | 40° | 90° | 140° | | 40° | 90° | 120° | | 40° | 90° | 140/ | | 40° | 90° | 140/ |
|---|---|---|---|---|---|---|---|---|---|---|---|---|---|---|---|---|
| | RT | F. | F. | F. | RT | F. | F. | F. | RT | F. | F. | 120° F. | RT | F. | F. | 120° F. |
| 1 Week | 40 | 40 | 40 | | 40 | 40 | 30 | | 270 | 380 | 230 | | 90 | 100 | 90 | |
| 2 Weeks | 40 | 50 | 50 | | 40 | 40 | 40 | | 270 | 370 | 220 | | 90 | 110 | 90 | |
| 3 Weeks | 40 | 50 | 40 | | 40 | 40 | 30 | | 270 | 360 | 240 | | 100 | 110 | 90 | |
| 4 Weeks | 40 | 50 | 40 | | 30 | 40 | 30 | | 260 | 350 | 230 | | 100 | 110 | 90 | |
| 1 Month | 30 | 40 | 40 | 30 | 30 | 40 | 50 | 30 | 260 | 360 | 220 | 190 | 90 | 110 | 90 | 120 |
| 2 months | 30 | 40 | 40 | 30 | 30 | 40 | 50 | 30 | 260 | 360 | 220 | 190 | 90 | 110 | 90 | 120 |
| 3 months | 40 | 50 | 40 | 30 | 40 | 40 | 40 | 40 | 270 | 370 | 230 | 220 | 100 | 110 | 90 | 160 |
| 4 months | 40 | 40 | 30 | 30 | 40 | 50 | 30 | 40 | 260 | 380 | 230 | 210 | 100 | 110 | 100 | 200* |
| 5 months | 30 | 50 | 40 | 30 | 30 | 50 | 40 | 30 | 260 | 380 | 220 | 220 | 100 | 120 | 100 | 240 |
| 6 months | 40 | 50 | 50 | 50 | 40 | 60 | 60 | 50 | 270 | 390 | 240 | 230* | 110 | 120 | 110 | 310 |

These aging studies demonstrated that the viscosities remained steady with time at each temperature for MEK, ACE, and THF. For CYH, the viscosity is seen to decrease with increasing storage temperature. This might be due to the varying degree of solvation of the thickener K-400. This data can be utilized to prepare primer compositions of appropriate viscosities.

### Example 11—Scale-Up and Aging Studies of Further Primer Compositions

Clear and purple-dyed primers were prepared and aging studies at room temperature were performed. Results for specified compositions are provided in Table 12, below.

TABLE 12

| | CLEAR PRIMERS | | | | | | PURPLE PRIMERS | | | |
|---|---|---|---|---|---|---|---|---|---|---|
| | Sample No. | | | | | | | | | |
| | 1 | 2 | 3 | 4 | 5 | 6 | 7 | 8 | 9 | 10 |
| THF | | | | | | | | | | 15.07 |
| MEK | 37.00% | 47.00% | 40.00% | 37.50% | 47.50% | 40.50% | 36.92% | 46.92% | 40.42% | 19.93 |
| CYH | 20.00% | 10.00% | 5.00% | 20.00% | 10.00% | 5.00% | 20.00% | 10.00% | 5.00% | 25 |
| ACE | 40.00% | 40.00% | 52.00% | 40.00% | 40.00% | 52.00% | 40.00% | 40.00% | 52.00% | 39.92 |
| Paraloid K-400 | 3.00% | 3.00% | 3.00% | 2.50% | 2.50% | 2.50% | 3.00% | 3.00% | 2.50% | |
| Violet Dye | | | | | | | 0.06% | 0.06% | 0.06% | 0.062 |
| Red Dye | | | | | | | 0.02% | 0.02% | 0.02% | 0.018 |
| TOTAL | 100.00% | 100.00% | 100.00% | 100.00% | 100.00% | 100.00% | 100.00% | 100.00% | 100.00% | 100 |
| Specific Gravity | | | | | | | | 6.825 | 6.752 | 7.088 |
| Viscosity, cp | | | | | | | | | | |
| Initial | 40 | 30 | 30 | 30 | 20 | 20 | 50 | 40 | 20 | 0 |
| 24 h | 50 | 50 | 40 | 30 | 20 | 20 | 50 | 40 | 20 | 0 |
| 1 week, RT | 40 | 40 | 30 | 30 | 20 | 20 | 50 | 40 | 20 | 0 |
| 2 weeks, RT | 40 | 40 | 40 | 20 | 20 | 10 | 50 | 40 | 20 | 0 |
| 3 weeks, RT | 50 | 40 | 30 | 20 | 20 | 10 | 50 | 40 | 20 | 0 |
| 4 weeks, RT | 40 | 40 | 30 | 20 | 30 | 10 | 40 | 40 | 20 | 0 |

In order to provide viscosity of 20 cps, it was necessary to reduce the resin content to 2.5 wt %.

Next, sample 8 was scaled up and an aging study of was performed. Data is provided in Table 13, below.

TABLE 13

| Constituent | Formula % |
|---|---|
| MEK | 46.92% |
| CYH | 10.00% |
| ACE | 40.00% |
| Paraloid K-400 | 3.00% |
| Violet Dye | 0.06% |
| Red Dye | 0.02% |
| Total | 100.00% |

| Viscosity (cP) | Room Temp. | 40° F. | 90° F. | 140° F. | 0° F. |
|---|---|---|---|---|---|
| As made | 30 | | | | |
| 24 hours | 40 | | | | |
| Week 1 | 40 | 50 | 40 | 40 | 70 |
| Week 2 | 40 | 50 | 50 | 40 | 80 |
| Week 3 | 30 | 40 | 40 | 30 | 60 |
| Week 4 | | | | | |
| Density (lbs/gal) | 6.828 | | | | |
| Dissolution Test | Failed | | | | |
| (Pass/Fail) | | | | | |

The viscosity data indicated that the tested composition had a stable viscosity at the various temperature points. However, the composition did not pass the dissolution test, which may have been because of the relatively low concentration of CYH.

What is claimed:

1. A primer composition for preparing a polymer surface for solvent cement bonding, the primer composition comprising:
a solvent component that is capable of softening the polymer surface;
a solvent-soluble thickener in an amount of about 0.5-6 wt %, based on the total weight of the primer composition,
wherein the primer composition has a viscosity of about 10-65 cps as measured according to ASTM D1084, Method B.

2. The primer composition according to claim 1, wherein the solvent component comprises acetone (ACE), cyclohexanone (CYH), methyl ethyl ketone (MEK), tetrahydrofuran (THF), or any combination thereof.

3. The primer composition according to claim 1, wherein the solvent component does not include tetrahydrofuran.

4. The primer composition according to claim 1, wherein the solvent component comprises about 25-55 wt % MEK, about 5-35 wt % CYH, and about 25-55 wt % ACE, based on the total weight of the primer composition.

5. The primer composition according to claim 1, wherein the solvent component comprises about 27-42 wt % MEK, about 10-30 wt % CYH, and about 27-42 wt % ACE, based on the total weight of the primer composition.

6. The primer composition according to claim 1, wherein the thickener has a molecular weight of at least 1,000,000 Dalton.

7. The primer composition according to claim 1, wherein the thickener has a molecular weight of 1,000,000 to 10,000,000 Dalton.

8. The primer composition according to claim 1, wherein the thickener is a polymer formed from ethyl acrylate, butyl acrylate, isobutyl acrylate, methyl methacrylate, butyl methacrylate, isobutyl methacrylate, methacrylic acid, styrene, or any combination thereof.

9. The primer composition according to claim 1, wherein the thickener is a polymer formed from methyl methacrylate.

10. The primer composition according to claim 1, wherein the thickener is a polymer formed from ethyl acrylate and methyl methacrylate.

11. The primer composition according to claim 1, wherein the thickener is a polymer formed from methyl methacrylate, butyl acrylate, and butyl methacrylate.

12. The primer composition according to claim 1, wherein the thickener is present in an amount of about 0.5-3 wt %, based on the total weight of the primer composition.

13. The primer composition according to claim 1, wherein the primer composition does not include any undissolved particles.

14. A method of preparing a polymer surface for solvent cement bonding to a further polymer surface comprising:
applying a primer composition according to claim 1 to the polymer surface.

15. A method of making a primer composition for preparing a polymer surface for solvent cement bonding, comprising combining (i) a solvent component that is capable of softening the polymer surface, and (ii) a solvent-soluble thickener in an amount of about 0.5-6 wt %, based on the total weight of the primer composition,
wherein the primer composition has a viscosity of about 10-65 cps as measured according to ASTM D1084, Method B.

16. The method according to claim 15, wherein the thickener has a molecular weight of at least 1,000,000 Dalton.

17. The method according to claim 15, wherein the thickener is a polymer formed from ethyl acrylate, butyl acrylate, methyl methacrylate, butyl methacrylate, or any combination thereof.

18. A kit comprising:
(i) a primer composition according to claim 1; and,
(ii) a solvent cement composition.

19. The kit according to claim 18, wherein the thickener has a molecular weight of at least 1,000,000 Dalton.

20. A kit comprising (i) a can defining an opening and an interior space that contains a primer composition according to claim 1, wherein the can comprises a cap for sealing the opening of the can, and (ii) a dauber for applying the primer composition onto a substrate, wherein the dauber is optionally affixed to a portion of the cap that faces the interior space of the can when the cap is positioned over the opening.
